(19) United States
(12) Patent Application Publication
(10) Pub. No.: US 2009/0128498 A1
(43) Pub. Date: May 21, 2009

(54) MULTI-LAYERED DISPLAY OF A GRAPHICAL USER INTERFACE

(75) Inventors: Gerard Hollemans, Eindhoven (NL); Huib V. Kleinhout, Waalre (NL); Henriette C. M. Hoonhout, Eindhoven (NL); Sander B.F. WIjdeven, Eindhoven (NL); Vincent Buil, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,922

(22) PCT Filed: Jun. 24, 2005
(86) PCT No.: PCT/IB2005/052105

§ 371 Date: Jan. 27, 2009

(51) Int. Cl. G06F 3/041

(52) U.S. Cl. 345/173

(57) ABSTRACT

A graphical user interface for a display uses 3-D sensing in order to manipulate various functions. In particular, instead of a menu being constantly on the display screen occupying space, when the finger of a user is at a certain distance from the screen, the menu then appears. By moving his/her finger in the X and/or Y direction, the user can make a selection from the displayed menu options. This method and GUI does not discriminate a certain part of the screen with less accessibility. Rather, the menu appears immediately in reaction to the user action, and the menu appears at the point of user input.

### FIELD OF THE INVENTION

The subject invention relates to display devices, and more particularly to a graphical user interface (GUI) for a display device.

A GUI displays icons on a display screen of a display device enabling a user to perform various functions by selecting the appropriate icon.

### DESCRIPTION OF THE RELATED ART

A GUI needs to be adapted to the available screen space of the display device. As such display devices get smaller, typically more space is needed than is available. This is particularly true for small devices, such as multimedia (audio, video, photos) players. For a typical application on such a device, there are three elements to be displayed, i.e., content (overview), status information, and functionality (copy, move, view, rotate, etc.).

To save on screen space devoted to displaying functionality, for example, a menu bar, the menu bar is often hidden. Hiding the menu bar implies that a mechanism is provided to the user to summon the menu (back) onto the screen. Assuming a touch screen, there are basically three options available to a user, i.e., a tapping on a specific part of the screen (usually top left corner), tapping on the screen and holding his/her finger or stylus on the screen until the menu appears, or provide a hard button (with a label, since a soft button requires screen space).

Each of these options has a drawback. Tapping on a specific part of the screen makes objects on that part of the screen less accessible as sometimes the menu will appear if a small mistake is made. Tapping and holding the finger or stylus on the screen requires a time out to prevent the menu from appearing if the user does not withdraw his/her finger or stylus sufficiently quickly. This time out makes the screen less responsive. The hard button requires space on the device, which usually is already small, and requires the user to leave the screen to call up the menu after which he/she has to return to the screen to make a selection in the menu. In other words, the menu appears in a different place from where the user calls for the menu.

This object is achieved in a method for selectively displaying a menu of options on a display screen of a display device, said method comprising the steps of detecting a distance that a finger of a user is from the display screen; generating a detection signal when said distance is within a predetermined threshold distance; determining a position of said user's finger with respect to said display screen; displaying said menu on said display screen at said determined position in response to said detection signal; further detecting movements of said user's finger in a plane parallel to the display screen; and using said detected further movements to effect selections from the menu options.

The object is further achieved in a graphical user interface for a display device for selectively displaying a menu of options on a display screen of the display device, said graphical user interface comprising means for detecting a distance that a finger of a user is from the display screen, said detecting means generating a detection signal when said distance is within a predetermined threshold distance; means for determining a position of said user's finger with respect to said display screen; means for displaying said menu on said display screen at said determined position in response to said detection signal; means for further detecting movements of said user's finger in a plane parallel to the display screen; and means for using said detected further movements to effect selections from the menu options.

For 3D virtual touch screens which are able to measure where a user's finger is with respect to the screen in X, Y, and Z coordinates using, for example, capacitive sensing, the above method and GUI enable the user to summon the menu (back) to the screen. When the finger of the user is at a certain distance from the screen, the menu then appears. By then moving his/her finger in the X and/or Y direction, the user can make a selection from the displayed menu options. This method and GUI does not discriminate a certain part of the screen with less accessibility. Rather, the menu appears immediately in reaction to the user action, and the menu appears at the point of user input.

In a particular embodiment, the method and GUI comprise generating said detection signal only when said user's finger initially comes within said predetermined threshold distance, and generating said detection signal when said user's finger begins to withdraw from said display screen. As such, in determining when to display the menu the method and GUI takes into account the distance (range) from the screen as well as the direction of the finger of the user. When the finger moves towards the screen, the menu should not appear. Rather, once the finger moves within range, the menu should only appear if the finger then moves away from the screen. This prevents the menu from appearing each time the user starts to use the device.

In a further particular embodiment, the method and GUI are characterized in that said generating step generates at least one further detection signal when said detecting step detects that the detected distance is within at least one further predetermined threshold distance, and said displaying step displays a first menu at said determined position in response to said detection signal and displays at least one further menu of said menu at said determined position in response to said at least one further detection signal. As such, when the finger arrives at a certain distance from screen, the method and GUI display several planes containing groups of functions (when the finger is) at different distances from the screen. In particular, the most often used options are displayed on the plane closest to the screen itself.

With the above and additional objects and advantages in mind as will hereinafter appear, the invention will be described with reference to the accompanying drawings, in which:

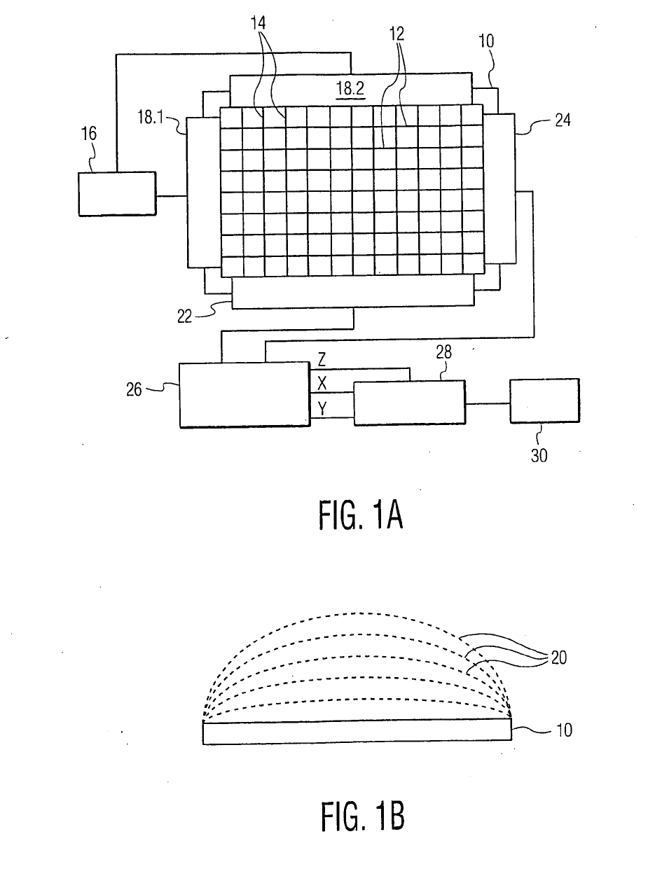

FIG. 1A is a block diagram of a display device having a capacitive sensor array incorporated therein;

FIG. 1B is a diagram showing the detection lines of the sensor array of FIG. 1A;

FIG. 2 is a diagram showing the detection zone extending from the surface of the display screen;

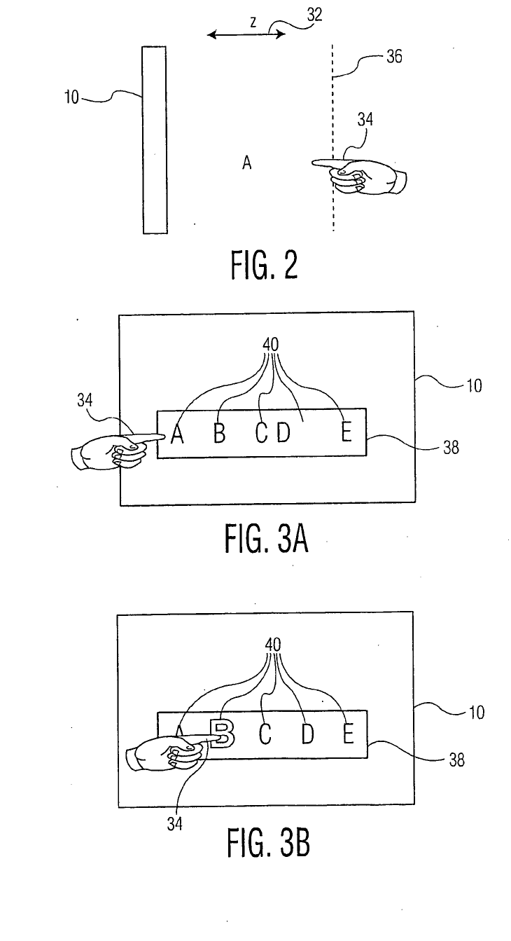

FIG. 3A shows a display screen in which a menu appears when the user's finger enters the detection zone of FIG. 2, and FIG. 3B shows the selection of an icon in the menu;

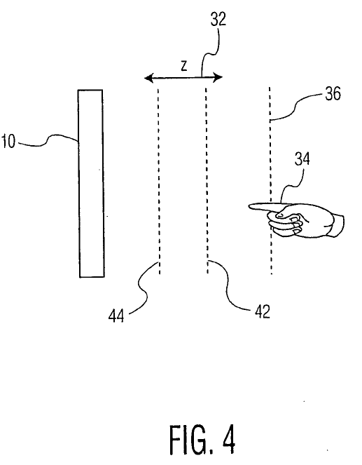

FIG. 4 is a diagram showing different threshold distances from the surface of the display screen; and

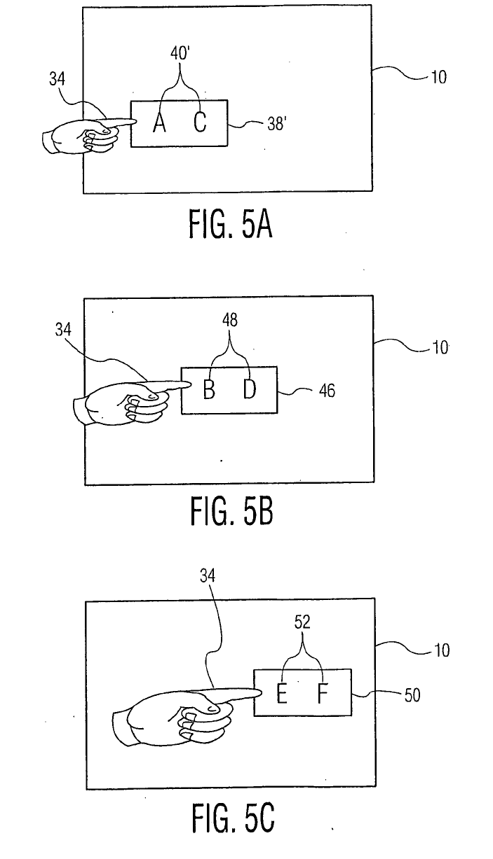

FIGS. 5A-5C show various menus appearing when a user's finger passes each of the threshold distances shown in FIG. 4.

The subject invention makes use of a 3-D display, that is, a display that is capable of detecting the horizontal and vertical position of a pointer, stylus or a user's finger with respect to the surface of the display, as well as the distance of the pointer, stylus or user's finger from the surface of the display. There are various known types of 3-D displays using, for example, infrared sensing, capacitance sensing, etc. One type of a 3-D display is disclosed in U.S. Patent Application Publication No. US2002/0000977 A1, which is incorporated herein by reference.

As shown in FIG. 1A, a display screen 10 has superimposed thereon a grid of electrically conductive transparent conductors in which the horizontal conductors 12 are electrically isolated from the vertical conductors 14. A voltage source 16 connected to connection blocks 18.1 and 18.2 applies a voltage differential across the horizontal and vertical conductors 12 and 14. This arrangement develops a detection field 20 extending away from the surface of the display 10 as shown in FIG. 1B, with the horizontal and vertical conductors 12 and 14 acting as plates of a capacitor.

When, for example, a user's finger enters the detection field 20, the capacitance is affected and is detected by X-axis detector 22, connected to the vertical conductors 14 and the Y-axis detector 24, connected to the horizontal conductors 12. A sensor controller 26 receives the output signals from the X and Y detectors 22 and 24 and generates X, Y coordinate signals and a Z distance signal. The X and Y coordinate signals are applied to a cursor and display controller 28 which then applies control signals to an On-Screen Display controller 30.

As shown in FIG. 2, the cursor and display controller 28 establishes a zone A extending in the Z direction (dual-headed arrow 32) from the surface of the display screen 10. The zone A denotes a zone in which, when the user's finger 34 passes a threshold distance 36, the user's finger 34 is detected and, in a first embodiment, the cursor and display controller 28 displays a menu 38 with menu icons 40 (e.g., “A”, “B”, “C”, “D” and “E”) as shown in FIG. 3A. By moving his/her finger 34 in the X and/or Y direction, the user can then make a selection of one of the icons 40 from the menu 38. In FIG. 3B, the selection of icon “B” is shown by the user's finger 34 overlying the icon “B” and the icon “B” being “boldfaced” and enlarged.

In a second embodiment of the invention, instead of the cursor and display controller 28 immediately displaying the menu 38 when the user's finger 34 enters the detection zone A, the cursor and display controller 28 tracks the movement of the user's finger 34. After initially entering the detection zone A, the cursor and display controller 28 detects when the user's finger begins to withdraw from the display screen 10. At that moment, the cursor and display controller 28 displays the menu 38. Alternatively, the cursor and display controller 28 suspends displaying the menu 38 until the user's finger 34 has been withdrawn by a predetermined amount to allow for other functions, for example, “drag and drop” to be effected by the user without the menu 38 appearing.

In a third embodiment of the invention, as shown in FIG. 4, the cursor and display controller 28 establishes a second and a third threshold distance 42 and 44 in addition to the threshold distance 36. Now, as in the first embodiment, when the user's finger 34 passes the threshold distance 36, the user's finger 34 is detected and the cursor and display controller 28 displays a menu 38′ with menu icons 40′ for possible selection by the user (see FIG. 5A). If, instead, the user continues to advance his/her finger 34 towards the display screen 10, when the threshold distance 42 is passed, the cursor and display controller 28 displays, as shown in FIG. 5B, a different menu 46 with menu icons 48 for possible selection by the user. Again, if the user continues to advance his/her finger 34 towards the display screen 10, when the threshold distance 44 is passed, the cursor and display controller 28 displays, as shown in FIG. 5C, yet another different menu 50 with menu icons 52 for possible selection by the user. Note that in FIGS. 5A-5C, the user's advancement of his/her finger 34 towards the screen 10 is illustrated by progressively larger sizes of the finger 34.

In general, there needs to be a small space in close proximity of the screen within which the presence of the user's finger will not cause the menu to be shown (even if the menu was being shown before the user's finger entered this small space. Otherwise, the menu would never disappear without a special additional action by the user, e.g., a click on the screen. This small space is shown in FIG. 4 as threshold distance 45.

Although this invention has been described with reference to particular embodiments, it will be appreciated that many variations will be resorted to without departing from the spirit and scope of this invention as set forth in the appended claims. The specification and drawings are accordingly to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts is intended to be required unless specifically indicated.

1. A graphical user interface for a display device for selectively displaying a menu (38) of options on a display screen (10) of the display device, said graphical user interface comprising:
means (22, 24, 26) for detecting a distance (Z) that a finger (34) of a user is from the display screen (10), said detecting means (22, 24, 26) generating a detection signal when said distance (Z) is within a predetermined threshold distance (36);
means (22, 24, 26) for determining a position of said user's finger (34) with respect to said display screen (10);
means (28, 30) for displaying said menu (38) on said display screen (10) at said determined position in response to said detection signal;
means (22, 24, 26) for further detecting movements of said user's finger (34) in a plane parallel to the display screen (10); and
means (28) for using said detected further movements to effect selections from the menu (38) options (40).

2. The graphical user interface as claimed in claim 1, wherein said detecting means (22, 24, 26) generates said detection signal only when said user's finger (34) initially comes within said predetermined threshold distance (36).

3. The graphical user interface as claimed in claim 2, wherein said detecting means (22, 24, 26) generates said detection signal when said user's finger (34) begins to withdraw from said display screen (10).

4. The graphical user interface as claimed in claim 3, wherein said detecting means (22, 24, 26) generates said detection signal when said user's finger (34) is withdrawn more than a predetermined amount.

5. The graphical user interface as claimed in claim 1, wherein said detecting means (22, 24, 26) generates at least one further detection signal when said detected distance (Z) is within at least one further predetermined threshold distance (42), and wherein said displaying means (28, 30) displays said menu (38) at said determined position in response to said detection signal and displays at least one further menu (46) at said determined position in response to said at least one further detection signal.

6. The graphical user interface as claimed in claim 5, wherein said menu (38′) contains basic options (40′), and said at least one further menu (46) contains menu options (48) most often used by the user.

7. The graphical user interface as claimed in claim 1, wherein said detecting means (22, 24, 26) generates a further detection signal when said user's finger (34) is within a further predetermined threshold distance (44) from the display screen, said further predetermined threshold distance (44) being less than said predetermined threshold distance (36), said displaying means (28, 30) stopping the display of said menu (38) in response to said further detection signal.

8. A method for selectively displaying a menu (38) of options on a display screen (10) of a display device, said method comprising the steps:
detecting (22, 24, 26) a distance (Z) that a finger (34) of a user is from the display screen (10);
generating a detection signal when said distance (Z) is within a predetermined threshold distance (36);
determining (22, 24, 26) a position of said user's finger (34) with respect to said display screen (10);
displaying (28, 30) said menu (38) on said display screen (10) at said determined position in response to said detection signal;
further detecting (22, 24, 26) movements of said user's finger (34) in a plane parallel to the display screen (10); and
using said detected further movements to effect selections from the menu (38) options (40).

9. The method as claimed in claim 8, wherein said generating step generates said detection signal only when said user's finger (34) initially comes within said predetermined threshold distance (36).

10. The method as claimed in claim 9, wherein said generating step generates said detection signal when said user's finger (34) begins to withdraw from said display screen (10).

11. The method as claimed in claim 10, wherein said generating step generates said detection signal when said user's finger (34) is withdrawn more than a predetermined amount.

12. The method as claimed in claim 8, wherein said generating step generates at least one further detection signal when said detecting (22, 24, 26) step detects that the detected distance is within at least one further predetermined threshold distance (42), and wherein said displaying (28, 30) step displays said menu (38) at said determined position in response to said detection signal and displays at least one further menu (46) at said determined position in response to said at least one further detection signal.

13. The method as claimed in claim 12, wherein said menu (38′) contains basic menu options (40′), and said at least one further menu (46) contains menu options (48) most often used by the user.

14. The method as claimed in claim 8, wherein said detecting (22, 24, 26) step generates a further detection signal when said user's finger (34) is within a further predetermined threshold distance (44) from the screen, said further predetermined threshold distance (44) being less than said predetermined threshold distance (36), said displaying (28, 30) step stopping the display of said menu (38) in response to said further detection signal.
